(19) United States
(12) Patent Application Publication
(10) Pub. No.: US 2012/0083939 A1
(43) Pub. Date: Apr. 5, 2012

(54) DYNAMIC CONTROL OF SMALL-SCALE ELECTRICAL LOADS FOR MATCHING VARIATIONS IN ELECTRIC UTILITY SUPPLY

(76) Inventor: Roger W. Rognli, Otsego, MN (US)

(21) Appl. No.: 13/252,754

(22) Filed: Oct. 4, 2011

Related U.S. Application Data
(60) Provisional application No. 61/389,362, filed on Oct. 4, 2010.

(51) Int. Cl. G06F 1/28

(52) U.S. Cl. 700/297

(57) ABSTRACT

A method of collectively controlling small-scale electrical loads receiving energy from an electricity grid that includes sources of renewable generation causing variable electricity supply so as to match collective electricity load to electricity supply. The method includes setting a runtime delay time, sensing a request for energy from the electrical loads, preventing the loads from receiving the energy for the first delay time, and adjusting the runtime delay time based on changes in electrical supply.

### RELATED APPLICATION

The present application claims the benefit of U.S. Provisional Application No, 61/389,362 filed Oct. 4, 2010, which is incorporated herein in its entirety by reference.

### FIELD OF THE INVENTION

The present invention relates generally to management and control of electrical loads. More particularly, the present invention relates to dynamic control of small-scale electrical loads to match variations in electricity supply.

### BACKGROUND OF THE INVENTION

Utilities need to match generation to load, or supply to demand. Traditionally, this is done on the supply side using Automation Generation Control (AGC). As loads are added to an electricity grid and demand rises, utilities increase output of existing generators to solve increases in demand. To solve the issue of continuing long-term demand, utilities invest in additional generators and plants to match rising demand. As load levels fall, generator output to a certain extent may be reduced or taken off line to match falling demand. Although such techniques are still used, and to a certain extent still address the problem of matching supply with demand, as the overall demand for electricity grows the cost to add power plants and generation equipment that serve only to fill peak demand makes these techniques extremely costly. Further, the time required to increase generator output or to take generators online and take generators offline creates a time lag, and a subsequent mismatch between supply and demand.

In response to the limitations of AGC, electric utility companies have developed solutions and incentives aimed at reducing both commercial and residential demand for electricity. In the case of office buildings, factories and other commercial buildings having relatively large-scale individual loads, utilities incentivize owners with differential electricity rates to install locally-controlled load-management systems that reduce on-site demand. Reduction of any individual large scale loads by such a load-management systems may significantly impact overall demand on its connected grid.

In the case of individual residences having relatively small-scale electrical loads, utilities incentivize consumers to allow them to install demand response technology at the residence to control high-usage appliances such as air-conditioning compressors, water heaters, pool heaters, and so on. Such technology aids the utilities in easing demand during sustained periods of peak usage. However, the impact of reducing any individual load does not significantly reduce overall demand or overall load on the supplying electrical grid, and there remains no easy way to quickly and collectively coordinate reducing loads of numerous, disparate residential customers having individually insignificant load demand. Consequently, reducing overall load on a grid by controlling small-scale loads remains challenging.

Furthermore, the challenges associated with matching load to generation have been exacerbated by the growing use of renewable energy sources. Renewable generation, primarily wind and solar, is not controllable to the same degree as conventional generation. Changing wind speeds and solar intensities cause renewable generators to produce electricity at variable, and sometimes unpredictable, rates. Further, many state governments are requiring utilities to install significant levels of renewable generation, thus heightening the challenges of balancing load and generation.

One attempt to address the volatility in renewable generation and its effect on electricity grids includes storing excess energy in batteries for later use. Another attempt relies on load-shifting. A typical example of load-shifting involves hydro-pumping, or using available excess electricity to pump water to a point above ground, then during times of lower supply and higher demand, allow the water to flow down to ground level to generate electricity. Although storage and load-shifting techniques offer an interim solution, significant capital must be invested, efficiency will be compromised, and real-time matching of load and generation remains elusive.

### SUMMARY OF THE INVENTION

Embodiments of the present invention include methods, devices and systems for collectively and dynamically controlling small-scale electrical loads so as to match a collective load demand with variable supply.

In one embodiment, the present invention comprises a method of controlling a small-scale electrical load receiving energy from an electricity grid that includes sources of renewable generation causing variable electricity supply and coupled to a communicative load-matching device having a controller, communication module and a switch, so as to match electricity load to electricity supply. The method includes setting a runtime delay time of the load-matching device to a first delay time; sensing at the load-matching device a request for energy from the electrical load; operating the load-matching device so as to prevent the electrical load from drawing energy from the electricity grid for a period of time substantially equal to the runtime delay time; sensing a first electricity supply parameter; and adjusting the runtime delay time of the load-matching device to be substantially equal to a second delay time based upon the first electricity supply parameter, thereby changing the period of time that the load-matching device prevents the electrical load from drawing power.

In another embodiment, the present invention comprises a method of collectively controlling a plurality of small-scale electrical loads receiving energy from an electricity grid that includes sources of renewable generation causing variable electricity supply and coupled to communicative load-matching devices having controllers, communication modules and switches, so as to match collective electricity load to electricity supply. The method includes setting a runtime delay time of each of the plurality load-matching device to a first delay time; sensing at each of the plurality of load-matching devices a request for energy from the electrical load coupled to the load-matching device; operating each of the load-matching device so as to prevent the coupled electrical load from drawing energy from the electricity grid for a period of time substantially equal to the runtime delay time; receiving a second delay time at each of the plurality of load-matching devices, the second delay time representative of an electricity supply condition; and adjusting the runtime delay time of each of the plurality of load-matching devices to be substantially equal to the second delay time, thereby changing the period of time that each of the plurality of load-matching devices prevents its respective electrical load from drawing power and changing a collective load on the electricity grid.

In yet another embodiment, the present invention comprises a load-matching device for dynamically controlling a small-scale electrical load receiving energy from an electricity grid that includes sources of renewable generation causing variable electricity supply. The load matching device includes a communications module including a transceiver for communicating over a communications network; a switch electrically connected to a power line of the electrical load and configured to interrupt power to the electrical load when in an open position; and a controller communicatively coupled to the communications module and the switch and including means for controlling the switch so as to delay the small-scale electrical load from receiving power for a variable delay time, a length of the variable delay time being dependent upon an electrical supply parameter.

In another embodiment, the present invention comprises a load-matching device to dynamically control a small-scale electrical load receiving energy from an electricity grid that includes sources of renewable generation causing variations in electricity supply so as to manage electricity load to the variable electricity supply. The device comprises: means for setting the timer of the load-matching device to a runtime delay time; means for sensing at the load-matching device a request for power from the electrical load; means for starting the timer of the load-matching device in response to the request for power from the electrical load; means for causing the load-matching device to prevent the electrical load from receiving power from the electricity supply while the timer is delaying for the runtime delay time; means for sensing a first parameter of the electricity supply; and means for causing the load-matching device to automatically adjust the runtime delay time set in the timer based upon the first parameter, thereby adjusting a delay time prior to which the electrical load receives power from the electricity supply.

In another embodiment, the present invention comprises a non-transitory, computer-readable medium storing instructions for implementing a method of controlling a small-scale electrical load receiving energy from an electricity grid that includes sources of renewable generation causing variations in electricity supply of the electricity grid, the small-scale electrical load coupled to a load-matching device having a timer and controller that manage electricity load to electricity supply for the electrical load. The method comprises: setting the timer of the load-matching device to a runtime delay time; sensing at the load-matching device a request for power from the electrical load; starting the timer of the load-matching device in response to the request for power from the electrical load; causing the load-matching device to prevent the electrical load from receiving power from the electricity supply while the timer is delaying for the runtime delay time; sensing a first parameter of the electricity supply; and causing the load-matching device to automatically adjust the runtime delay time set in the timer based upon the first parameter, thereby adjusting a delay time prior to which the electrical load receives power from the electricity supply.

### BRIEF DESCRIPTION OF THE DRAWINGS

The invention may be more completely understood in consideration of the following detailed description of various embodiments of the invention in connection with the accompanying drawings, in which:

FIG. 1 is a diagram of an electricity generation and distribution grid that includes sources of renewable energy connected to the grid, according to an embodiment of the present invention;

FIG. 2 is a diagram of a premise having an electrical load controlled by a dynamic delay time control system; according to an embodiment of the present invention;

FIG. 3 is a simplified flowchart of a delay process according to an embodiment of the present invention;

FIG. 4 is a diagram of a premise having an electrical load controlled by a dynamic delay time control system, according to another embodiment of the present invention;

FIG. 5a is a graph depicting demand versus time for the case of an incremental rise in demand;

FIG. 5b is a graph depicting delay time versus time for the case of an incremental rise in demand as depicted in FIG. 5a;

FIG. 6a is a graph depicting demand versus time for the case of an incremental fall in demand;

FIG. 6b is a graph depicting delay time versus time for the case of an incremental fall in demand as depicted in FIG. 6a;

FIG. 7 is a flowchart of a delay time adjustment process according to an embodiment of the present invention;

FIG. 8a is a graph depicting demand versus time for an extended period of time and for the case of multiple changes in demand;

FIG. 8b is a graph depicting delay time versus time for an extended period of time and for the case of multiple changes in demand as depicted in FIG. 8a;

FIG. 9 is a diagram of the electricity generation and distribution grid of FIG. 1, depicting various zones of control;

FIG. 10a is a graph depicting delay time versus time for an extended period of time and for the case of changing frequency; and

FIG. 10b is a graph depicting frequency versus time for an extended period of time and corresponding to the delay time graph of FIG. 10a.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE DRAWINGS

Embodiments of the present invention include methods, systems, and devices for dynamically matching electrical loads with electrical supply. Such methods, systems and devices include controlling operations of the electrical loads by adjusting a load delay time based on local and remote inputs.

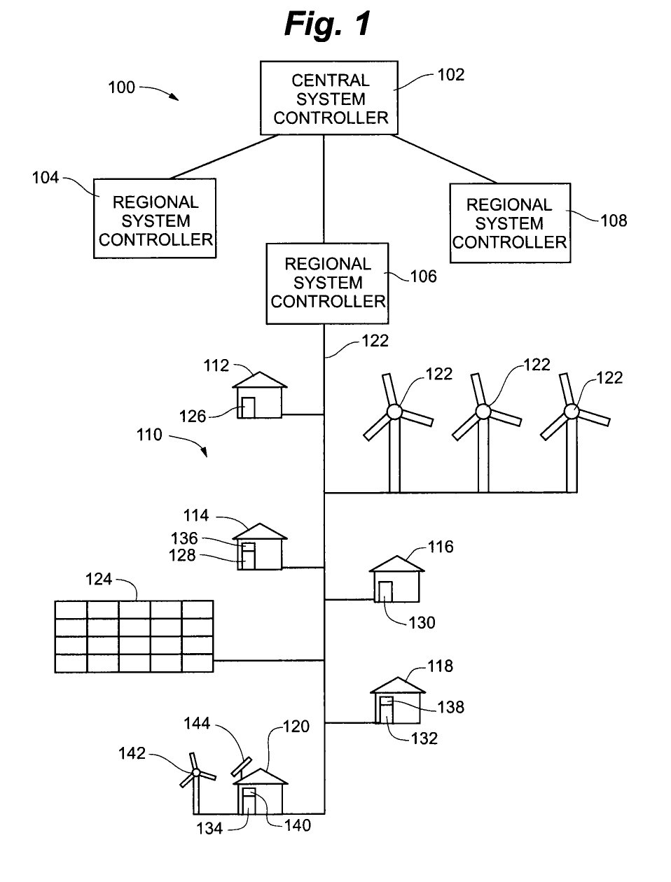

Referring to FIG. 1, an electricity generation and distribution grid 100 is depicted. Grid 100 includes central system controller 102 in communication with multiple regional system controllers 104, 106, and 108. In an embodiment, central system controller 102 comprises a power generation plant having centralized control over generation and distribution of electrical power throughout grid 100. In other embodiments, central system controller 102 may not be the point of generation, but comprises a centralized point of control and communication. Regional system controllers 104, 106 and 108 may be substations or other distribution and/or control points for controlling generation and distribution of electricity to regional areas, in conjunction with central system controller 102.

Each regional system controller 104, 106, and 108 controls distribution, and in some cases generation, of electricity over a regional sub-grid to a plurality of users. As depicted, regional system controller 106 controls distribution and generation of electricity over regional sub-grid 110. In the embodiment depicted, premises 112, 114, 116, 118 and 120 receive energy over distribution network 122. Regional sources of renewable energy, such as wind turbines 122 and solar panel array 124, or other such renewable sources, may also be connected to sub-grid 110 via distribution network 122, thus supplying energy to sub-grid 110 and grid 100.

Each of the plurality of premises 112, 114, 116, 118 and 120 include at least one electrical load 126, 128, 130, 132, and 134, respectively, that draw energy from grid 100. Small-scale electrical loads include not only electrical loads of residential buildings, such as single-family homes, but may also include electrical loads of multi-unit housing complexes, smaller office buildings, farms, light-commercial and retail buildings. In these types of applications, small-scale electrical loads draw less than 250 kW of electrical power. Although grid 100 may also include large-scale electrical loads, such as those concentrated at factories and other commercial sites, such loads are not the subject of the present invention. Hereinafter, the term “electrical load” will generally understood to refer to small-scale electrical loads utilizing less than 250 kW.

Some premises may include load-matching devices (LMDs), such as premise 114 with LMD 136, premise 118 with LMD 138, and premise 120 with LMD 140. LMDs 136, 138, and 140 may be controlled in a number of ways by local internal, local external, regional, and central control parameters, as described further below, in order to control each individual load, as well as the collective load on grid 100.

In some embodiments, a premise might also include premise-located renewable energy sources. As depicted, premise 120 includes two types of renewable energy generators, micro-turbine 142 and solar panel 144. Such generators typically provide electrical energy to premise 120, and in many cases, may connect directly to distribution network 122 to supply excess power to grid 100.

Unlike traditional electricity grids that include a single generation source, such as a centralized power plant connected to multiple electrical loads, grid 100 includes multiple generation sources as well as multiple controlled and uncontrolled loads. The renewable energy sources supply power to grid 100 dependent on local conditions. Turbines 122 supply relatively more power to grid 100 on windy days, while solar array 124 supplies more power on sunny days. Matching electricity supply to demand becomes increasingly difficult as the relative amount of volatile renewable energy sources connected to grid 100 grows.

As discussed above, common solutions to match supply and demand include bringing additional generators online, load-shifting, and reducing peak-time loading. Such solutions may require significant investment in technology and equipment at local, regional, and central locations. On the other hand, the present invention provides load-based solutions to balance electricity supply and demand by not only decreasing load on grid 100 when electricity supply is down, but also by increasing load on grid 100 when supply is up.

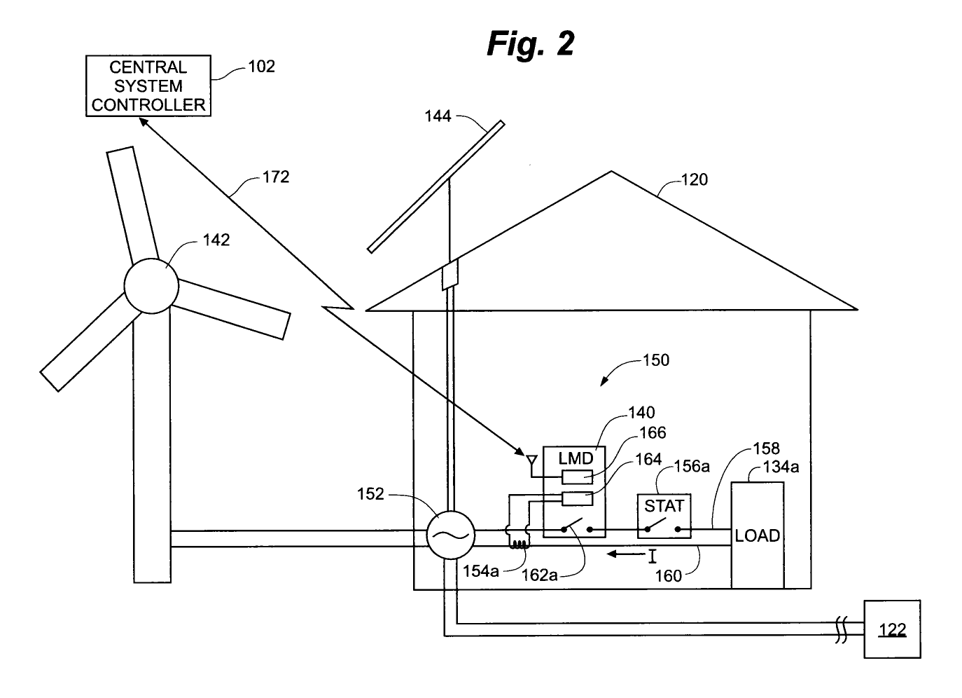

Referring to FIG. 2, an embodiment of a dynamic load-matching system, system 150 is depicted. System 150 includes power source 152, load-matching device (LMD) 140, optional sensor 154, thermostat 156a and load 134a. Supply power from power source 152 is supplied to load 134a via a power-supply distribution circuit that includes lines 158 and 160. In the embodiment depicted. LMD 140 and thermostat 156a are connected in series along one of the supply power lines, in this case, line 158. Sensor 154 is electrically coupled to LMD 140 and the power-supply distribution circuit at line 160.

It will be understood that power source 152 as depicted is a simplified representation of multiple sources of power, including power supplied from grid 100 via, distribution network 122, and power from local renewable energy sources, which in the depicted embodiment includes micro-turbine 142 and solar panel 144. Although not depicted, power source 152 may also include inverters and other power conditioning and control equipment related to micro-turbine 142 and solar panel 144 as needed to supply power to premise 120 and potentially to grid 100.

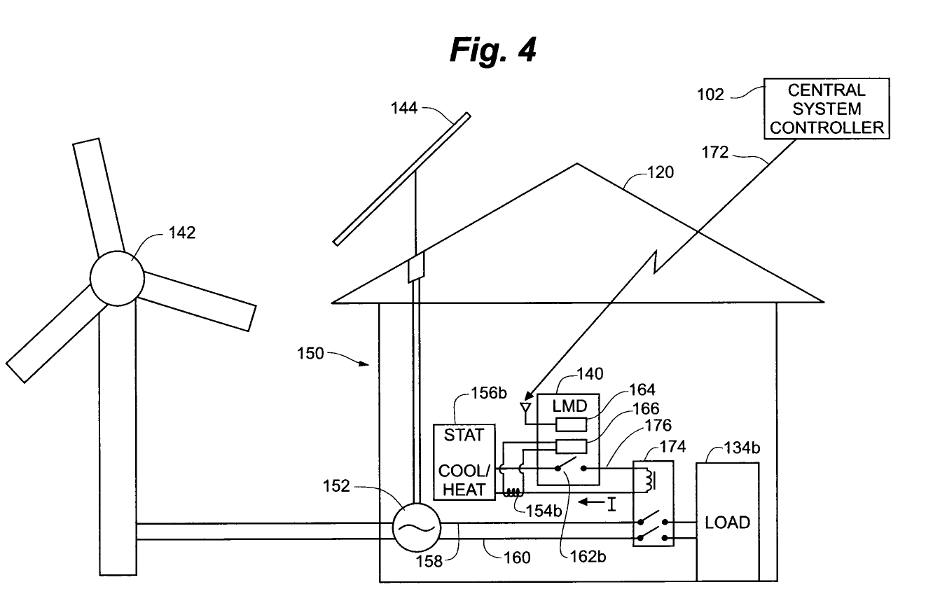

Load 134a may be one or more electrical loads, including various heating and cooling devices. Such loads 134a that provide heat include hot water heaters, pool heaters, electric heaters, and so on. In an embodiment, these heating loads 134a may be resistive heating loads. Loads 134a that provide cooling include refrigerators, freezers, or heating-ventilating and air-conditioning (HVAC) compressors, and other such compressor based loads. FIG. 4 discloses an alternate embodiment of the present invention that includes an HVAC-specific system, as will be discussed further below. FIG. 2 depicts a system 150 having a resistive load 134a with an LMD directly in line with power source 152.

Still referring to FIG. 2, as depicted, thermostat 156a may be a simple, non-communicative thermostat that opens and closes an internal switch to allow load 134a to turn on and off in order to maintain a desired temperature set point. In other embodiments, thermostat 156a may be a more sophisticated communicative thermostat or control device that also powers load 134a on and off as required. Although the depicted embodiment of system 150 includes thermostat 156a, it will be understood that other devices used to control load 134a may be utilized. In an embodiment, load 134a may be an electric water heater operating on 120 VAC/60 Hz power, and thermostat 156a may comprise a water heater thermostat having a simple bimetallic switch that opens and closes as a water temperature respectively rises above and falls below a temperature set point.

LMD 140 in an embodiment includes switch 162a, controller 164, and communications module 166. Switch 162a may be a relay switch, or other power-switching device, located in line with line 158, such that when switch 162a is open, power is interrupted to load 134a, and when closed, power flows to load 134a, dependent on thermostat 156a. Switch 162a is communicatively coupled to controller 164, which controls the operation of switch 162a.

Controller 164 comprises a combination of hardware, software, and firmware for controlling switch 162a. Controller 164 may include one or more processors, volatile and non-volatile memory storing computer programs, timers, power supply and conditioning circuits, buses, and other such electrical circuitry. Timers may be implemented in the hardware, firmware, or software, or a combination thereof. Embodiments of timers include digital counters that count up or down. In embodiments including detector 154a, controller 164 is communicatively coupled to detector 154a to receive detected information, including one or more of current, frequency and voltage input from the supply-power circuit. As depicted, detector 154a comprises a current transformer, capable of detecting current I flowing in line 160.

In the embodiment depicted, LMD 140 also includes communications module 166. Communications module 166 may include a combination of hardware, software, and firmware. Communications module 166 may be a separate module, distinct from controller 164, or in other embodiments may be integrated into controller 164. Communications module 166 in some embodiments may include a transceiver, one or more processors, volatile and non-volatile memory, and an antenna. Communications module 166 generally provides one-way or two-way communications capability to LMD 140.

Communications module 166 of LMD 140 may communicate over a long-haul network to a regional or central controller, such as over network 172 to central system controller 102. Network 172 is linked to central system controller 102, and facilitates one-way or two-way communications, with transmission of data accomplished using a variety of known wired or wireless communication interfaces and protocols including power line communication (PLC), broadband or other interact communication, radio frequency (RE) communication, and others. Network 172 may also comprise an advanced metering infrastructure (AMI) mesh network.

In an embodiment, network 172 is an RF network transmitting and receiving data via radio towers. Network 172 can be implemented with various communication interfaces including, for example, VHF or FLEX one-way paging, AERIS/TELEMETRIC Analog Cellular Control Channel two-way communication, SMS Digital two-way communication, or DNP compliant communications for integration with SCADA/EMS communications currently in use by electric generation utilities.

In other embodiments, communications module 166 communicates over a long-haul network that may include a combination of cable, telephone, Internet, and possibly even short- to medium-range networks utilizing local repeaters or other such known devices.

Communications module 166 may also be able to communicate over a short-haul network which may be a wired or wireless communication network capable of communicating over a relatively short range. Such a short-haul network may comprise a local network with coverage that potentially extends somewhat beyond the confines of premise 120, or may be a premise-centric network, such as a wireless personal area network (WPAN), home-area network (HAN), home plug network, building area network, or similar network.

In other embodiments, 140 may not include communications module 166, such that operation of LMD 140 is not determined by data provided by central or regional controllers, but rather is determined solely by local parameters.

In general operation, and according to the embodiment depicted, thermostat 156a makes and breaks in response to a temperature set-point of load 134a. When an actual temperature, such as a water temperature, is at or above a temperature set point, thermostat 156a will be open, interrupting power to load 134a. When the actual temperature falls below a temperature set point, thermostat 156a will close. If switch 162a of LMD 140 is also closed, load 134a is powered and operational. If switch 162a of LMD 140 is open, load 134a is not powered. Only when both thermostat 156a and LMD 140 are “made”, or both switches closed, will load 134a operate and draw power from grid 100 or local renewable sources.

LMD 140 shares some characteristics, with known load-control receivers (LCRs), such as LCRs described in U.S. Pat. No. 7,702,424 and U.S. Pat. No. 7,355,301, commonly assigned to the assignee of the present application, and herein incorporated by reference in their entireties. Such characteristics include the general capability to communicate over a long-haul network with a central controller and the ability to open and close a switch so as to interrupt power to a load. LMD 140 may work in conjunction with such known LCRs and demand response technology.

In one embodiment, LMD 140 is initially in a closed position. More specifically, when an actual or sensed temperature is at or above a set point temperature, and thermostat 156a is open, switch 162a of LMD 140 begins in a closed position. When the actual temperature falls below a temperature set point, thermostat 156a closes, thus allowing power source 152 to deliver power to load 134a. Current I begins to flow in line 160. LA/D 140 senses current flow in line 160 via detector 154a, which in the depicted embodiment is a current detector. Controller 164 then causes switch 162a to open, disrupting power to load 134a.

Controller 164 then continues to hold switch 162a open, despite the call for energy from thermostat 156a. After a delay time, controller 164 allows switch 162a to close, thereby allowing load 134a to be powered. In one embodiment, the delay time is implemented by a timer of controller 164, and as discussed further below, is adjustable.

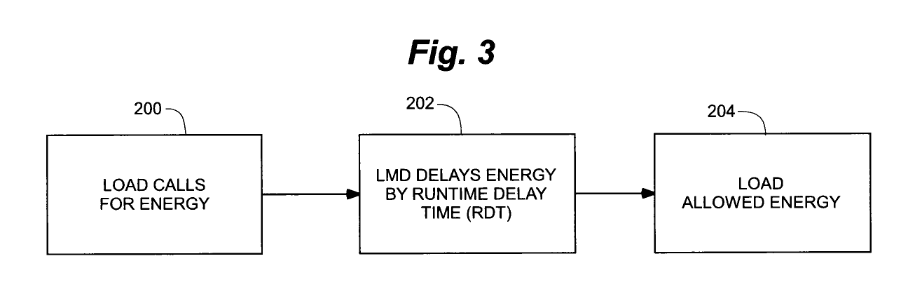

A simplified version of this process is depicted in FIG. 3. At step 200, load 134a calls for energy. At step 202, rather than allow load 134a to receive energy, LMD 140 delays the flow of energy to load 134a for a period of time. This period of time is referred to hereinafter as a delay time, or as a Runtime delay time (Rain. After the expiration of the delay time, at step 204, load 134a is allowed energy.

By dynamically controlling the length of the delay time, and the length of time that power to load 134a is delayed, electrical demand on grid 100 may be manipulated such that the overall load on grid 100 is dynamically changed to match variations in supply. Such variations in supply may be due to the short-term volatility inherent in renewable energy sources, including wind gusts, cloud cover, and so on. Reducing a delay time will bring on extra load (increase demand) for a short period of time, while increasing a delay period will tower load (decrease demand) for a short period of time.

Referring to FIG. 4, an alternate embodiment of a dynamic load matching system of the present invention is depicted. System 150 of FIG. 4 is substantially similar to system 150 of FIG. 2, with a few modifications. Load 134b in the depicted embodiment is a compressor-based. HVAC toad, such as an air-conditioning compressor. In some embodiments, load 134b in this embodiment may draw more power than toad 134a, operating at higher voltage and current conditions. Contactor 174, not present in system 150 of FIG. 2, operates to turn power to load 134b on and off. In this embodiment, LMD 140, detector 154, and thermostat 156b operate on a low-voltage control circuit to control load 134b.

In general operation, thermostat 156b calls for heat or cool via a low-voltage signal at one of a heat or cool terminal output of thermostat 156b. If switch 162b of LMD 140 is in the closed position, the low-voltage signal is sensed at contactor 174, causing contractor 174 switches to close, thus applying power to load 134b. If switch 162b of LMD 140 is open, no control signal will be detected at contactor 174, and load 134b will remain without power.

As will be discussed further below, delay times for loads 134a and 134b may be controlled locally, or remotely, at regional, or at central levels, and may correspondingly be based upon local, regional, or central parameters. As will also be discussed further below, such parameters may include line-under or line-over frequency, line-under or line-over voltage, power factor, amperage, solar intensity, wind speed, and so on.

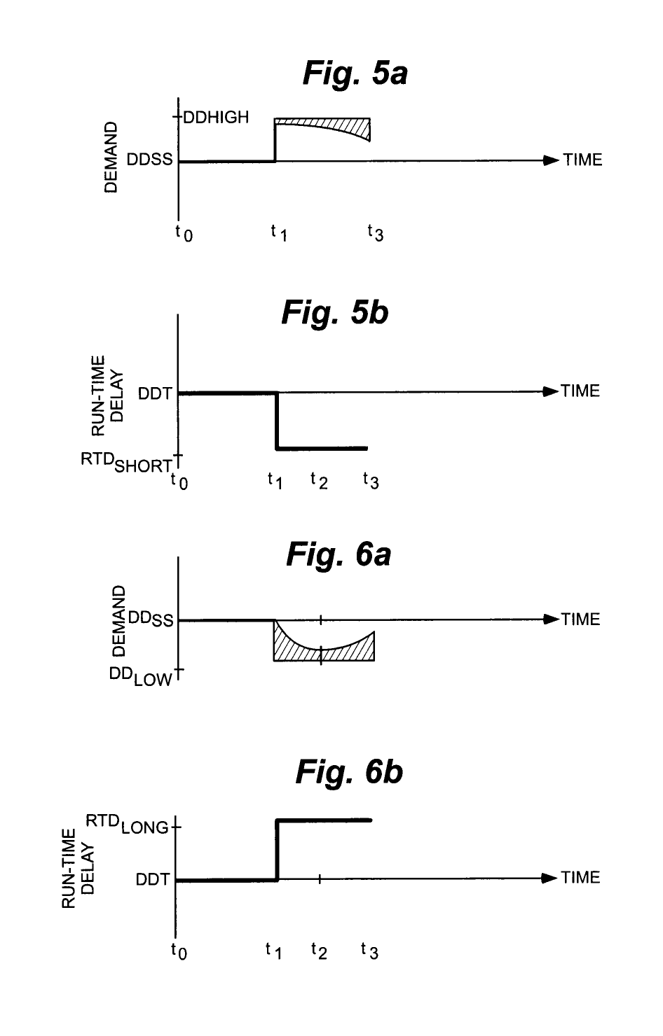

Referring to FIGS. 5a to 6b, the basic relationship between delay time and energy demand is illustrated. Referring specifically to FIGS. 5a and 5b, a graph of diversified demand versus time is illustrated in FIG. 5a, and a corresponding graph of delay time, referred to as Runtime delay time (RDT), versus time is illustrated in FIG. 5b. Diversified demand refers to the sum of energy demand created by a plurality of loads 134 (which potentially includes both resistive loads 134a and compressor-based loads 134b) connected to grid 100. The same description applies to any individual load 134, though the impact of an individual load 134 on grid 100 will generally be minimal. RDT refers to the actual delay time active and applied to a load 134.

Referring to both FIGS. 5a and 5b, at time t₀, diversified demand is at a steady state level (DD_{SS}) while the RDT is at a Default Delay Time (DDT). Such a DDT may be programmed into LMDs 140 initially and/or communicated to LMDs 140 at any point in time. After systems 150 have reached a steady state with a delay time of DDT, then the diversified demand levels off to a steady state diversified demand level (DD_{SS}), the demand level that it would have been without a time delay.

At time t₁, if RDT₀ is decreased from default DDT to a lower value, RDT_{SHORT}, as depicted, then individual loads 134 that have been waiting for the expiration of their previous RDT no longer have to wait, and may be powered. This in turn causes a rapid rise in diversified demand at t₁ to DD_{HIGH} for a period of time as LMDs 140 allow loads 134 to be powered on. Consequently, demand for energy is dynamically “created” in the short-term by decreasing a delay time.

Eventually, as loads 134 are satisfied, i.e., run until they reach temperature set point or otherwise satisfy their energy needs, individual loads 134 begin to turn off, and diversified demand decays towards DD_{SS} as depicted at time t₃.

Referring to FIGS. 6a and 6b, the effect of increasing runtime delay time (RDT) beyond the default delay time (DDT) is depicted. Again, at t₀, steady state conditions apply such that diversified demand is at DDss, and RDT₀ is initially at DDT. During this steady state, loads 134 will be turning on as needed after waiting out an RDT equal to the default DDT. Likewise, loads 134 will turn off as electrical needs are satisfied. In other words, during a steady state, although all loads share a common runtime delay time, loads 134 are not running synchronously, nor turning on and off synchronously.

At time t₁, in this embodiment, RDT for all loads is increased to RDT_{LONG}, which is greater than DDT. At that point in time, t₁, some individual loads 134 may be powered because of a previous call for power and because their RDT had expired, and some will not be powered. Of those that are not powered, some will not be powered because there has been no call for power, others will not be powered because there bias been a call for power, but their delay time has not yet expired, and they are waiting to be powered. Those loads that were waiting to be powered will wait longer. The additional wait time is the difference between the new RDT, namely RDT_{LONG}, and the previous steady-state RDT, namely DDT. In an embodiment, those loads 134 that are running at t₁, may be turned off for an additional time equal to the time difference between RDT_{LONG} and DDT, or for another lesser amount of time.

Consequently, the increase in RDT from DDT to RDT_{LONG} at t₁ causes demand to begin to decay from DDss to DD_{LOW} as more and more loads 134 are delayed, thus reducing demand by increasing a delay time for LMDs 140 and their loads 134.

As individual loads 134 experience the expiration of their new longer RDTs, they will begin to be powered, and demand begins to rise from time t₂ to time t₃, approaching the steady state demand DDss. The exact shape of the demand curve will vary in part based upon the actual distribution of the start times, or points in time when loads 134 call for energy and delay times begin to toll.

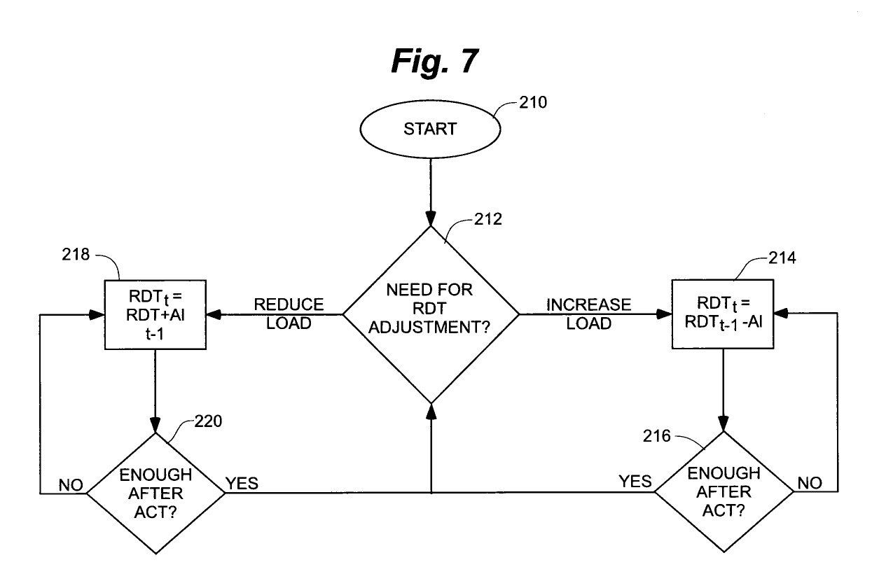

Referring to FIG. 7, a process for dynamically adjusting delay time RDT is depicted. After starting at step 210, a determination of the need for a delay time RDT adjustment is made at step 212. This determination will be described further below, but generally, a need to increase or decrease load will drive an adjustment in delay time.

If there is a need to increase load to match supply, at step 214, RDT will be decreased by an adjustment increment (AI). Whether the RDT decrement is sufficient is determined at step 216. At step 216, the determination is made after an adjustment cycle time (ACT). The ACT is defined as the number of cycles or time between delay time calculations. The ACT may be decreased for increased system sensitivity, and increased for decreased system sensitivity. If the decrement is insufficient, RDT is again decreased by AI at step 214, until the decrement is sufficient. Once the delay time RDT is determined to be sufficient, at step 212, the delay time RDT is reevaluated.

If at step 212 it is determined that the load needs to be reduced to match dwindling supply, at step 218, RDT will be increased by one AI. If at step 220 the adjustment to RDT is considered insufficient, the RDT is again increased at step 218. Steps 218 and 220 repeat until RDT in sufficiently increased and load sufficiently reduced.

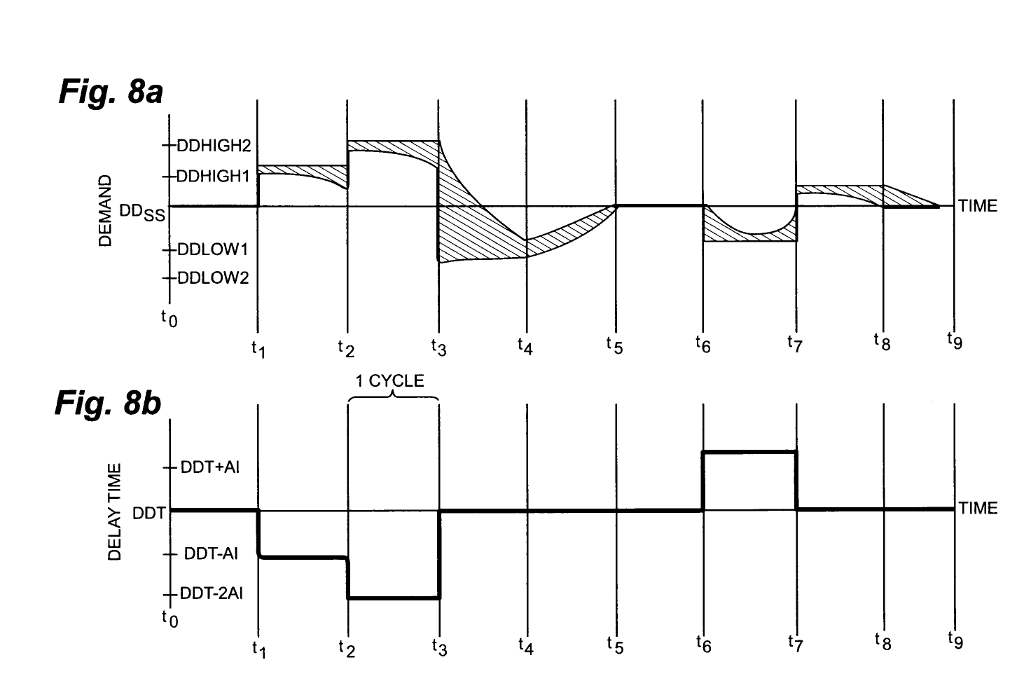

Referring to FIGS. 8a and 8b, using the process of FIG. 7 for increasing and decreasing demand, a utility may continuously adjust the load on grid 100 by increasing or decreasing the Runtime Delay Time RDT. When the RDT is decreased, there is a corresponding increase in load (demand) for some amount of time, then as that load gets satisfied, the increased demand decays back to the steady state diversified demand of the load. If however, the RDT is decreased farther, another increase in demand occurs.

Such an effect is illustrated from time t₀ to time t₃. At time t₀, RDT starts at a steady state value of DDT, then falls at time t₁ by one adjustment increment AI to DDT-AI for one time period. During this time period, from time t₁ to t₂, the diversified demand rises abruptly from DDss to DD_{HIGH1}, and then begins to decay towards DDss. Prior to reaching DDss, at time t₂, RDT is increased again by an increment AI, such that the RDTₜ₂=DDT-2AI. Subsequently, at time t₂, diversified demand increases to DD_{HIGH2}, and then begins to decay towards DDss over the time period starting at t₂ and ending at t₃.

If the RDT is suddenly increased, the load on grid 100 drops. For those loads 134 that are resistive loads, such as a load 134a, and that may have turned on prior to an increase in RDT, may be forced off within the time difference between the prior and new RDT, being forced off for the additional time difference. Such a feature may be referred to as a re-shed capability. In other embodiments, such resistive loads 134 may not be forced off, depending on the needs of the utility. For compressor loads 134, such as AC or refrigeration loads 134b, in an embodiment, such loads may not be forced off again once they have been powered up so as to avoid short-cycling and possible damage to the compressor load. As a result, the overall demand decrease resulting from an increase in RDT may be more gradual than the corresponding demand increase resulting from a decrease in RDT. In some embodiments, and as discussed further below, the re-shed capability may be a parameter or identifier programmed into the firmware or software of LMD 140.

Such an increase in RDT is depicted at t₃, wherein the RDT at time t₃, RDTₜ₃, is increased by two adjustment increments to DDT. Subsequently, diversified demand begins to decay downwards past DD_{SS} to a point DD_{LOW1}. As the RDT remains constant from time t₃ to t₅, diversified demand rises again to DD_{SS}.

At time t₆, another decrease in demand is desired, and the RDT is increase by another increment AI such that RDTₜ₆=DDT+AI, causing diversified demand to decrease over the first portion of the cycle bounded by t₆ and t₇. As RDT remains constant over this time period, diversified demand begins to rise again during the latter portion of the cycle.

At time t₇, RDT is decreased by an increment AI, causing another increase in demand, followed by a gradual decay to DDss from time t₇ to time t₉, as RDT is held constant at DDT.

Such dynamic time delay adjustments may be made based on real-time and predicted variations in electricity supply due to renewable generation so as to continuously match grid load to supply. As discussed briefly above, a number of considerations or parameters may be considered when determining and controlling the delay time of LMDs 140.

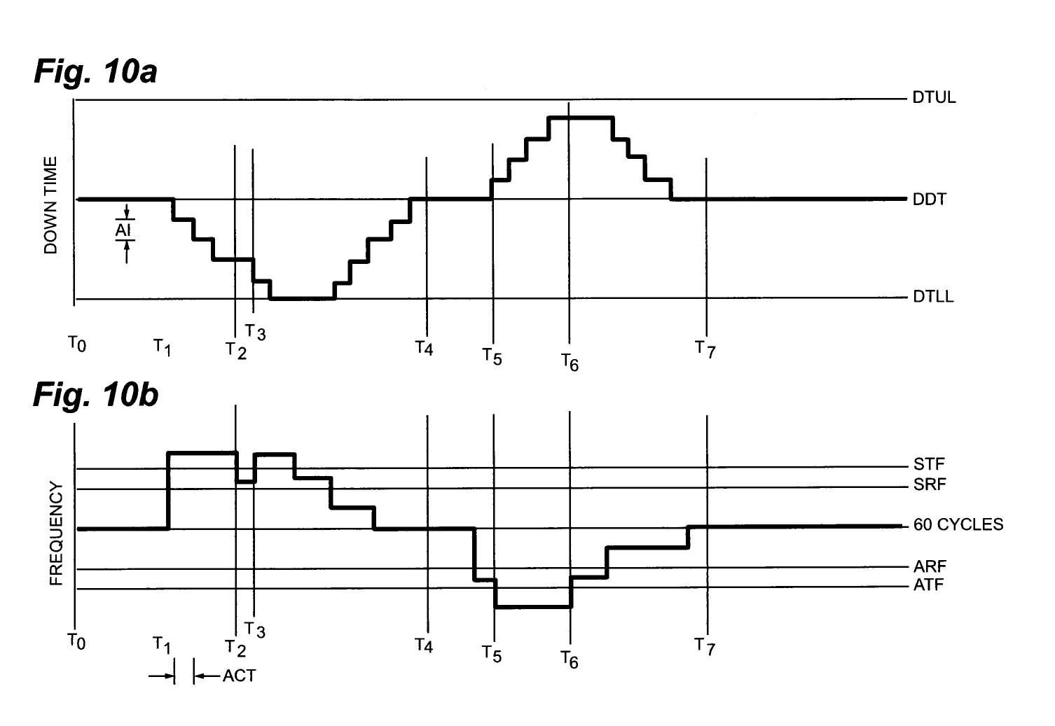

Although FIGS. 8a and 8b show RDT adjustments happening at discrete time intervals, and with discrete RDT steps, it will be understood that both the time intervals and RDT steps can be decreased and approach zero, effectively giving continuous control. A single command or other trigger may also cause the RDT to change in a continuous fashion, such as by linearly increasing, or by utilizing other higher-order functions, rather than purely in the step-like fashion depicted. This is illustrated in FIGS. 10a and 10b below.

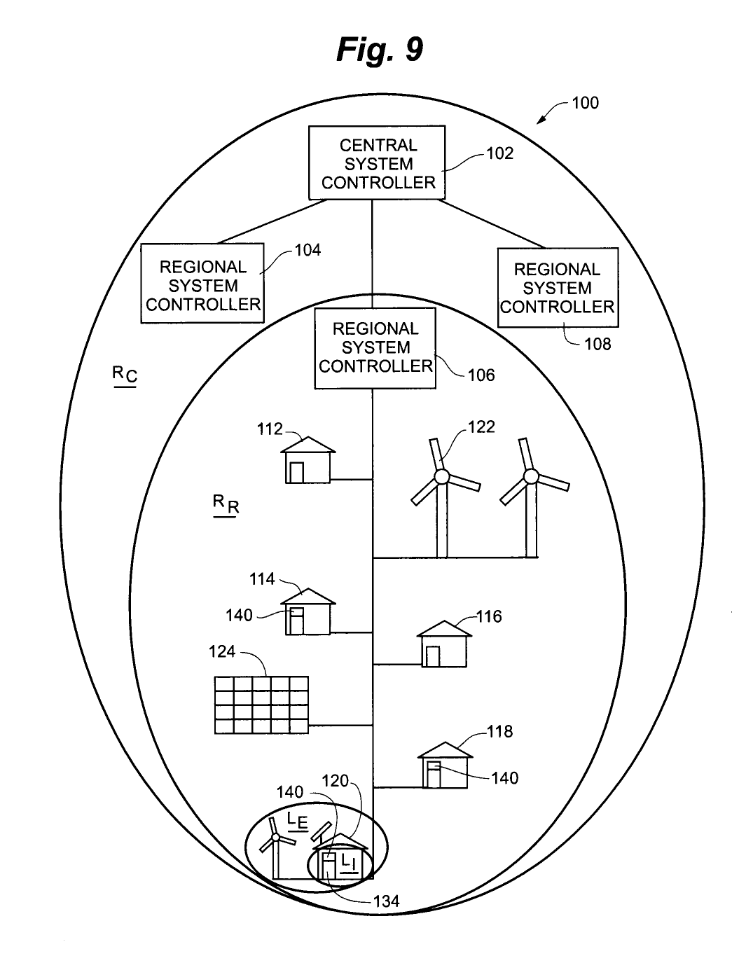

Referring to FIG. 9, a number of triggers or parameters may be used to determine and control the implementation of delay time or RDT. In one embodiment, parameters used to determine a delay time may be grouped into local and remote categories as follows: local internal depicted in region L₁ of FIG. 9, local external depicted in region L_{E}, remote regional depicted in region R_{R}, and remote central depicted in region R_{C}. Any combination of these categories of parameters may be used to determine a desired delay time and control its implementation.

Local internal control parameters may include power parameters such as frequency, voltage, amperage, or power factor as measured at or near premise 120, and possibly at particular loads 134. Often, when the electrical load on a grid 100 begins to rise above an optimal level, supply power frequency decreases and/or supply voltage decreases. Power factors may also decrease. During such times, demand begins to exceed supply, and 140 may dynamically increase its delay time until such locally measured parameters indicate that demand more closely matches supply.

As will be discussed further below. LMD 140 may sense line-under frequency or voltage conditions through detector 154, or through other sensing devices coupled to power source 152 (not depicted).

Similarly, when local power conditions indicate over frequency or over voltage conditions, supply typically exceeds demand. In such a situation, delay time may dynamically be shortened, or eliminated altogether, in order to bring load online as quickly as possible.

Local external parameters used to determine delay time of an individual premise LMD 140 may include parameters relating to local, primarily external factors. In an embodiment, LMD 140 includes the ability to receive a local signal from a device or system located at or near premise 120 and adjusts a delay time based on the received signal and its corresponding data. Data may include information relating to (premise-generated electricity, (premise-consumed electricity, solar intensity, wind speed, and so on, as received from premise inverters, meters, outdoor sensors, and other communicative sensing and consuming equipment located at or near premise 120. Such data may be received by communications module 166 of LMD 140 over a local or short-haul, wired or wireless network as discussed above with reference to FIGS. 2 and 3. Such data may be processed at 140 or processed remotely and provided to LMD 140.

In an embodiment, LMD 140 receives a signal from a photovoltaic system, or solar panel 144 of FIG. 2, indicating real-time electricity generation. In response to a relatively high output of energy, in some cases greater than the current needs of premise 120, a delay time of LMD 140 may be decreased to increase load.

Further, an LMD 140 after determining an appropriate delay time for itself based on local internal parameters may communicate information or instructions to other local or remote LMDs 140 over a short-haul network, or via long-haul network 172 and regional controller 106 and/or central controller 102, as depicted in FIG. 2.

As such, delay time may be adjusted and controlled at a local level based on premise internal and external parameters.

Delay times for LMDs 140 may also be determined based on remote regional or remote system-wide considerations such that multiple LMDs 140 adjust their own delay times based on these additional considerations, or are controlled directly by regional system controllers 104, 106, 108 or by central system controller 102.

With respect to regional considerations and control, LMDs 140 located within a particular region, or connected to a particular distribution line 122, may be supplied with regional information in order to determine an appropriate delay time. Such information may include information about regional voltage or frequency levels, and may be communicated from regional controllers 106 or central controller 102 via network 172. In an embodiment, each LMD 140 may determine its own delay time by combining received remote information with local information. In another embodiment, LMDs 140 receive commands to set their individual delay times per received command data such that all LMDs 140 in a particular region or area operate with the same delay time.

In some embodiments, once an LMD 140 determines an appropriate delay time and course of action, it sends information and/or instructions to other LMDs 140 in a local area, regional area, or system-wide. It may accomplish this by rebroadcasting its own control information, including delay time, to LMDs 140 sharing an appropriate group address. The priority of such control messages may be at a lower priority than local commands.

Further, control may also be initiated or adjusted at a system level, from central system controller 102, based on parameters, load levels, frequency, voltage and other information available at a system level and disseminated to LMDs 140.

Consequently, each LMD 140 may factor in local and remote data to determine an appropriate delay time so as to dynamically match load to supply. Local information or parameters include parameters particular to premise equipment and devices (“local internal”) as well as local external parameters, such as wind, solar intensity, and so on. Remote information may include regional and system-wide parameters, including electricity quality parameters such as voltage, frequency, power factor, and so on.

Referring to FIGS. 10a and 10b, a pair of graphs depicting a dynamic adjustment of delay time based on power frequency is depicted. More specifically, FIG. 10a depicts delay time versus time, and FIG. 10b depicts frequency versus time.

As discussed above, delay time may be adjusted using a number of local and remote parameters. Such parameters may include power quality parameters measured locally or regionally. As such, a line-over or line-under voltage (LOUV) or a line-over or line-under frequency (LOU) process may be used to dynamically adjust delay time. In an embodiment, delay time may be set to a specified time as commanded by a regional or central controller, or other controlling/requesting device, or may be incrementally increased or decreased.

In the embodiment depicted in FIGS. 10a and 10b, power line frequency is monitored and delay time adjusted accordingly. Frequency may be monitored at a local premise 120 such that premise LMD 140 delays power to a premise load 134, or may be monitored at a regional location such as a substation, with multiple LMDs 140 delaying power to multiple loads 134. Some examples of monitoring LOUV and LOUF and shedding a load in response are found in U.S. Pat. No. 7,242,114 and U.S. Pat. No. 7,595,567 commonly assigned to the assignee of the present application, and are herein incorporated by reference in their entireties.

For the purposes of illustration, and for implementing a frequency adjustment process in an algorithm of LMD 140, a number of additional terms are defined as follows: Delay Time Lower Limit (DTLL) is defined as the lower limit of the delay time range; Delay Time Upper Limit (DTUL) is defined as the upper limit of the delay time range; Add Trigger Frequency (ATF) is defined as the frequency below which AI is added to the RDT when DTUL>RDT>DDT; Add Trigger Voltage (ATV) is defined as the voltage below which AI is added to the RDT when DTUL>RDT>DDT; Add Restore Frequency (ARF) is defined as the frequency above which AI is subtracted from the RDT when DTUL>RDT>DDT; Add Restore Voltage (ARV) is defined as the voltage above which AI is subtracted from the RDT when DTUL<RDI<DDT; Subtract Trigger Frequency (STF) is defined as the frequency above which AI is subtracted from the RDT when DDT>RDT>DTLL; Subtract Trigger Voltage (STY) is defined as the voltage above which AI is subtracted from the RDT when DDT>RDT>DTLL; Subtract Restore Frequency (SRF) is defined as the frequency below which AI is added to the MDT when DDT>RDT>DTLL; Subtract Restore Voltage (SRV) is defined as the voltage below which AI is added to the RDT when DDT>RDT>DTLL; Re-shed capability (as discussed above) is indicated by the bit 0 or 1 to indicate if a controlled load is allowed to be turned off quickly after starting in response to an increase in RDT, and priority is an indication of whether a frequency driver or voltage driver takes priority at a given time.

Further, with respect to priority, in an embodiment, LMT 140 will prioritize commands coming in from local internal, local external, regional remote, and central remote levels. Those received commands may have priorities assigned to them in such a way that if the priority exists in the message, the priority should be used, but if there is no priority in the message, a stored priority of LMT 140 is used.

It will be understood that although FIGS. 10a and 10h and the corresponding description refer to an adjustment process based on frequency parameters, a similar process may be implemented using corresponding voltage parameters.

Referring still to both FIGS. 10a and 10b, frequency versus time and delay time (RDT) versus time are respectively plotted for a time period T₀ to T₇. At time T₀, steady-state conditions, measured frequency is at 60 Hz, and delay time is set to a default value, DDT.

At T₁, frequency increases beyond the Subtract Trigger Frequency (STF), indicating an excess supply of energy, RDT is subsequently dropped one adjustment increment (AI) for each Adjustment Cycle Time (ACT) in order to add demand to match the excess supply. At time T₂, in response to the decrease in RDT, the frequency drops down between the SIP and the Subtract Restore Frequency (SRF), and RDT is held constant until time T₃.

At time T₃, frequency rises again above the STF, and RDT is shortened or adjusted downward, until the frequency is at a value between the STF and the SRF, during which time RDT is held constant. As the frequency falls below the SRF between times T₃ and T₄, the RDT is incremented by AI until the RDT reaches DDT at T₄, and a steady state is again reached.

Between T₄ and T₅, it is shown that the frequency may fluctuate between SIP and ATF without any RDT modifications being made as in this range the RDT decays toward the steady state DDT. At T₅, the frequency falls below the ACT. In response, the RDT is increased by AI for each cycle ACT until either the RDT hits the DTUL or the frequency rises above the ATF. If the frequency stays between the SRF and the ARF, then the RDT remains constant and the diversified demand decays to the DDT, as it does between time T₆ and T₇.

Similar logic holds if the parameters are based on the voltage, or even another parameter, including power quality, is used.

Accordingly, the present invention provides methods, devices and systems for collectively and dynamically controlling small-scale electrical loads so as to match a collective load demand with variable supply.

Although the present invention has been described with respect to the various embodiments, it will be understood that numerous insubstantial changes in configuration, arrangement or appearance of the elements of the present invention can be made without departing from the intended scope of the present invention. Accordingly, it is intended that the scope of the present invention be determined by the claims as set forth.

For purposes of interpreting the claims for the present invention, it is expressly intended that the provisions of Section 112, sixth paragraph of 35 U.S.C. are not to be invoked unless the specific terms “means for” or “step for” are recited in a claim.

1. A method of controlling a small-scale electrical load receiving energy from an electricity grid that includes sources of renewable generation causing variations in electricity supply of the electricity grid, the small-scale electrical load coupled to a load-matching device having a timer and controller that manage electricity load to electricity supply for the electrical load, the method comprising:
setting the timer of the load-matching device to a runtime delay time;
sensing at the load-matching device a request for power from the electrical load;
starting the timer of the load-matching device in response to the request for power from the electrical load;
causing the load-matching device to prevent the electrical load from receiving power from the electricity supply while the timer is delaying for the runtime delay time;
sensing a first parameter of the electricity supply;
causing the load-matching device to automatically adjust the runtime delay time set in the timer based upon the first parameter, thereby adjusting a delay time prior to which the electrical load receives power from the electricity supply.

2. The method of claim 1, wherein sensing at the load-matching device a request for power from the electrical load comprises sensing electrical current in an electrical line supplying power to the electrical load using a current transformer.

3. The method of claim 1, wherein sensing a first parameter of the electricity supply comprises sensing a frequency of the electricity supply.

4. The method of claim 1, wherein sensing a first parameter of the electricity supply comprises sensing a voltage of the electricity supply.

5. The method of claim 1, wherein sensing a first parameter of the electricity supply comprises sensing a power factor of the electricity supply.

6. The method of claim 1, wherein sensing a first parameter of the electricity supply comprises sensing a first parameter of the electricity supply at a remote location.

7. The method of claim 6, wherein sensing a first parameter of the electricity supply comprises sensing a first parameter of the electricity supply at a premise where the electrical load is located.

8. The method of claim 1 further comprising sensing a second parameter of the electricity supply, and causing the load-matching device to automatically adjust the runtime delay time set in the timer based upon the first and the second parameter.

9. The method of claim 1, wherein setting the timer of the load-matching device to a runtime delay time comprises receiving a runtime delay time at a communication module of the load-matching device, the runtime delay time transmitted over a communications network by a remote controller.

10. The method of claim 1, wherein setting the timer of the load-matching device to a runtime delay time comprises setting the timer of the load-matching device prior to installation at a premise.

11. The method of claim 1, wherein causing the load-matching device to prevent the electrical load from receiving power from the electricity supply while the timer is delaying the runtime delay time comprises causing a switch of the load-matching device connected to a power line of the electrical load to open.

12. The method of claim 1, wherein causing the load-matching device to automatically adjust the runtime delay time set in the timer based upon the first parameter comprises increasing a runtime delay time so as to decrease load on the electricity supply.

13. The method of claim 1, wherein causing the load-matching device to automatically adjust the runtime delay time set in the timer based upon the first parameter comprises decreasing a runtime delay time so as to increase load on the electricity supply.

14. The method of claim 1, wherein causing the load-matching device to automatically adjust the runtime delay time set in the timer based upon the first parameter comprises receiving an adjusted runtime delay time from a remote controller.

15. A load-matching device to dynamically control a small-scale electrical load receiving energy from an electricity grid that includes sources of renewable generation causing variations in electricity supply so as to manage electricity load to the variable electricity supply, the device comprising:
a switch electrically connectable to a power line of the small-scale electrical load and configured to selectively delay power to the electrical load; and
a controller communicatively coupled to the switch, the controller including a timer defining a runtime delay time and a sensor that detects a request for power from the electrical load, the controller being configured to cause the switch to delay power to the electrical load for the runtime delay time and to automatically adjust the runtime delay time based on a first parameter sensed as to the electricity supply, thereby dynamically adjusting a delay time prior to which the electrical load receives power from the electricity supply.

16. The load-matching device of claim 15, further comprising a communication module including a transceiver that communicates over a communications network.

17. The load-matching device of claim 16, wherein the communication module is configured to receive the runtime delay time as transmitted from a remote source over the communications network.

18. The load-matching device of claim 15, wherein the switch is a relay switch.

19. The load-matching device of claim 15, wherein the electrical load comprises a resistive electrical load.

20. The load-matching device of claim 15 further comprising a processor configured to adjust the runtime delay time based on the first parameter.

21. The load-matching device of claim 15, further comprising a current sensor in communication with the controller and configured to detect a request for power from the electrical load.

22. A load-matching device to dynamically control a small-scale electrical load receiving energy from an electricity grid that includes sources of renewable generation causing variations in electricity supply so as to manage electricity load to the variable electricity supply, the device comprising:
means for setting the timer of the load-matching device to a runtime delay time;
means for sensing at the load-matching device a request for power from the electrical load;
means for starting the timer of the load-matching device in response to the request for power from the electrical load;
means for causing the load-matching device to prevent the electrical load from receiving power from the electricity supply while the timer is delaying for the runtime delay time;
means for sensing a first parameter of the electricity supply; and
means for causing the load-matching device to automatically adjust the runtime delay time set in the timer based upon the first parameter, thereby adjusting a delay time prior to which the electrical load receives power from the electricity supply.

23. The load-matching device of claim 22, wherein the means for sensing a first parameter of the electricity supply comprises sensing a first parameter selected from a group consisting of a frequency of the electricity supply, a voltage of the electricity supply, and a power factor of the electricity supply.

24. The load-matching device of claim 22 further comprising means for sensing a second parameter of the electricity supply, and means for causing the load-matching device to automatically adjust the runtime delay time set in the timer based upon the first and the second parameter.

25. The load-matching device of claim 22, wherein the means for setting the timer of the load-matching device to a runtime delay time comprises receiving a runtime delay time at a communication module of the load-matching device, the runtime delay time transmitted over a communications network by a remote controller.

26. The load-matching device of claim 22, wherein the means for causing the load-matching device to prevent the electrical load from receiving power from the electricity supply while the timer is delaying the runtime delay time comprises causing a switch of the load-matching device connected to a power line of the electrical load to open.

27. The load-matching device of claim 22, wherein the means for causing the load-matching device to automatically adjust the runtime delay time set in the timer based upon the first parameter comprises increasing a runtime delay time so as to decrease load on the electricity supply.

28. A non-transitory, computer-readable medium storing instructions for implementing a method of controlling a small-scale electrical load receiving energy from an electricity grid that includes sources of renewable generation causing variations in electricity supply of the electricity grid, the small-scale electrical load coupled to a load-matching device having a timer and controller that manage electricity load to electricity supply for the electrical load, the method comprising:
setting the timer of the load-matching device to a runtime delay time;
sensing at the load-matching device a request for power from the electrical load;
starting the timer of the load-matching device in response to the request for power from the electrical load;
causing the load-matching device to prevent the electrical load from receiving power from the electricity supply while the timer is delaying for the runtime delay time;
sensing a first parameter of the electricity supply;
causing the load-matching device to automatically adjust the runtime delay time set in the timer based upon the first parameter, thereby adjusting a delay time prior to which the electrical load receives power from the electricity supply.

29. The non-transitory, computer-readable medium of claim 28, wherein the method step of causing the load-matching device to prevent the electrical load from receiving power from the electricity supply while the timer is delaying the runtime delay time comprises causing a switch of the load-matching device connected to a power line of the electrical load to open.

30. The non-transitory, computer-readable medium of claim 28, wherein the method step of causing the load-matching device to automatically adjust the runtime delay time set in the timer based upon the first parameter comprises increasing a runtime delay time so as to decrease load on the electricity supply.
